(19) United States
(12) Patent Application Publication
(10) Pub. No.: US 2026/0162171 A1
(43) Pub. Date: Jun. 11, 2026

(54) METHODS AND SYSTEMS FOR DESCRIBING AN ITEM-LISTING BY COMPREHENDING IMAGES

(71) Applicant: eBay Inc., San Jose, CA (US)

(72) Inventors: Tez Deepthi Tammineni, San Jose, CA (US); Shrivatsan Navalpakkam Rajagopalan, San Mateo, CA (US)

(21) Appl. No.: 18/977,103

(22) Filed: Dec. 11, 2024

(51) Int. Cl. G06Q 30/0601; G06V 30/14

(52) U.S. Cl. CPC G06Q 30/0641; G06Q 30/0627; G06V 30/1448

(57) ABSTRACT

One or more images of an item on a publication platform or to be published on a publication platform are accessed. The text content from the one or more images of the item are extracted. A description of the item is determined based on the extracted text content. The description of the item is displayed on an interactive interface on a user device. A response to the displayed description (e.g., a modification of the displayed description by a user of the user device) is received. A modified description based on the response to the displayed description is published on the publication platform.

### TECHNICAL FIELD

Embodiments of the present disclosure relate generally to item listing (also referred to as product listing), and, more particularly, but not by way of limitation, to methods and systems for automatically describing listings of items on a publication platform by comprehending images of the items.

### BACKGROUND

Publication platforms are digital or physical spaces where individuals, organizations, or entities can publish and distribute their content, products, or services to a wider audience. The publication platforms may include social media platforms, content management systems, academic repositories, video-sharing platforms, e-commerce platforms, and news outlets, etc. Publication platforms, such as e-commerce platforms, have become essential marketplaces for buying and selling products. These platforms rely heavily on accurate and detailed product listings to facilitate successful transactions between sellers and buyers.

Traditional methods of creating product listings require sellers to manually enter detailed product information, which is both time-consuming and error-prone. This manual process often results in incomplete or inaccurate listings, leading to buyer dissatisfaction and product returns. The challenge is particularly significant for sellers dealing with multiple products, where the manual entry process can become annoying and burdensome for their daily operations.

Additionally, the lack of standardization in manually created listings can result in missing critical product information, such as safety warnings or regulatory compliance details, potentially exposing both sellers and platforms to liability risks.

Furthermore, for visually impaired users who rely on screen readers and other assistive technologies. The original text content embedded within product images, which often contains crucial product information, safety warnings, and usage instructions, is often inaccessible to these users if the seller does not manually include them. This creates a significant barrier to access and potentially excludes a segment of potential buyers from fully understanding the products.

### SUMMARY

In some aspects, the techniques described herein relate to a system including: one or more hardware processors; and at least one machine-storage medium storing instructions that, when executed by the one or more hardware processors, cause the system to perform operations including: accessing one or more images of an item on a publication platform; extracting text content from the one or more images of the item; determining a description of the item based on the extracted text content; causing display of the description of the item on an interactive interface on a user device; receiving, via the interactive interface, a response to the displayed description (e.g., a modification of the displayed description by a user of the user device); and publishing, on the publication platform, a modified description based on the response to the displayed description.

In some aspects, the techniques described herein relate to a system, wherein the extracted text content includes regulatory information or warning information about the item.

In some aspects, the techniques described herein relate to a system, wherein the regulatory information or warning information about the item is extracted based on an identification of a hazardous material symbol in the one or more images.

In some aspects, the techniques described herein relate to a system, wherein the extracting of the text content from the one or more images of the item includes extracting the text content using an image recognition and text extraction algorithm.

In some aspects, the techniques described herein relate to a system, wherein the determining of the description of the item includes determining the description based on the extracted text content using a Chain of Thought (COT) algorithm.

In some aspects, the techniques described herein relate to a system, wherein the operations further include: identifying a plurality of items on the publication platform to target for description updates; accessing image data associated with each of the identified plurality of items; extracting the text content from image data for the each of the identified plurality of items; determining an updated description for the each of the identified plurality of items based on the corresponding extracted text content; and automatically updating the description for the plurality of items on the publication platform.

In some aspects, the techniques described herein relate to a system, wherein the operations further include: determining the description of the item is insufficient; and in response to determining the description of the item is insufficient, generating a notification to a user requesting the user to provide additional images of the item.

In some aspects, the techniques described herein relate to a system, wherein the operations further include: receiving the additional item images provided by the user; extracting text content of the additional item images; determining additional description of the item based on the extracted text content of the additional item images; and publishing the additional description of the item on the publication platform.

In some aspects, the techniques described herein relate to a system, wherein the description includes at least one of: a country of manufacture, a universal product code (UPC), a model, a manufacturing part number (MPN), a brand, or manufacturer information.

In some aspects, the techniques described herein relate to a system, wherein the extracted text content corresponds to a first language, wherein the operations further include: translating the extracted text content in the first language to a second language; and determining the description of the item in the second language based on the translated text content.

In some aspects, the techniques described herein relate to a system, wherein the one or more images include images of a package of the item.

In some aspects, the techniques described herein relate to a method including: accessing one or more images of an item on a publication platform; extracting text content from the one or more images of the item; determining a description of the item based on the extracted text content; causing display of the description of the item on an interactive interface on a user device; receiving, via the interactive interface, a response to the displayed description; and publishing, on the publication platform, a modified description based on the response to the displayed description.

In some aspects, the techniques described herein relate to a method, wherein the extracted text content includes regulatory information or warning information about the item.

In some aspects, the techniques described herein relate to a method, wherein the regulatory information or warning information about the item is extracted based on an identification of a hazardous material symbol in the one or more images.

In some aspects, the techniques described herein relate to a method, wherein the extracting of the text content from the one or more images of the item includes extracting the text content using an image recognition and text extraction algorithm.

In some aspects, the techniques described herein relate to a method, wherein the determining of the description of the item includes determining the description based on the extracted text content using a Chain of Thought (COT) algorithm.

In some aspects, the techniques described herein relate to a method, further including: identifying a plurality of items on the publication platform to target for description updates; accessing image data associated with each of the identified plurality of items; extracting the text content from image data for the each of the identified plurality of items; determining an updated description for the each of the identified plurality of items based on the corresponding extracted text content; and automatically updating the description for the plurality of items on the publication platform.

In some aspects, the techniques described herein relate to a method, further including: determining the description of the item is insufficient; and in response to determining the description of the item is insufficient, generating a notification to a user requesting the user to provide additional images of the item.

In some aspects, the techniques described herein relate to a method, further including: receiving the additional item images provided by the user; extracting text content of the additional item images; determining additional description of the item based on the extracted text content of the additional item images; and publishing the additional description of the item on the publication platform.

In some aspects, the techniques described herein relate to a machine-storage medium for storing instructions that, when executed by one or more hardware processors, cause the one or more hardware processors to perform operations including: accessing one or more images of an item on a publication platform; extracting text content from the one or more images of the item; determining a description of the item based on the extracted text content; causing display of the description of the item on an interactive interface on a user device; receiving, via the interactive interface, a response to the displayed description; and publishing, on the publication platform, a modified description based on the response to the displayed description.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of examples, and not limitations, in the accompanying figures.

FIG. 1 is a block diagram showing an example data system, according to various examples of the present disclosure.

FIG. 2 is a schematic diagram illustrating capturing of item images using a user device, according to various examples of the present disclosure.

FIG. 3 is a schematic diagram illustrating an example item image displayed on the user device, according to various examples of the present disclosure.

FIG. 4 is a diagram illustrating an interactive interface for reviewing and/or modifying extracted item descriptions displayed on the user device, according to various examples of the present disclosure.

FIG. 5 is a diagram illustrating an example webpage of the item listing with extracted and modified item descriptions, according to various examples of the present disclosure.

FIG. 6 is a diagram illustrating an example item with hazard symbols and warning text that can be automatically detected and extracted, according to various examples of the present disclosure.

FIG. 7 is a diagram illustrating an interactive interface for selecting and/or editing hazard warnings for item descriptions, according to various examples of the present disclosure.

FIG. 8A is a flowchart illustrating an example method for generating product listings, according to various examples of the present disclosure.

FIG. 8B is a flowchart illustrating example operations for processing extracted text content using a trained Artificial Intelligence (AI) model and a Chain of Thought (COT) verification to generate item descriptions, according to various examples of the present disclosure.

FIG. 9 is a flowchart illustrating an example method for handling insufficient item descriptions, according to various examples of the present disclosure.

FIG. 10 is a block diagram illustrating a representative software architecture, which may be used in conjunction with various hardware architectures herein described, according to various examples of the present disclosure.

FIG. 11 is a block diagram illustrating components of a machine able to read instructions from a machine-readable medium and perform any one or more of the methodologies discussed herein, according to various examples of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various embodiments may be given throughout this description. These are merely descriptions of specific embodiments. The scope or meaning of the claims is not limited to the embodiments given.

It should be noted that the term “item” or “product” in the present disclosure may be used interchangeably to refer to a real-world product or a virtual service product, unless stated otherwise. The term “item listing” or “product listing” may refer to a publication of information of an item on a publication platform (e.g., an e-commerce platform). The information of the item may include specifications, warnings, regulatory compliance details, and other relevant information about the item.

Various embodiments include systems, methods, and non-transitory computer-readable medium for generating item listings on a publication platform (e.g., an e-commerce platform). The system accesses images of an item through multiple resources. For example, a user may capture and upload images using a user device (also referred to as a client device) such as a mobile phone, a tablet, or a computer through a client software application installed on the client device. Alternatively, the images may be retrieved from a storage, a remote server, or a database connected to the system through a wired or wireless network. The images may be captured from various sources that contain textual information about the item, such as packages, labels, user manuals, specification sheets, safety data sheets, or other documentation associated with the item. However, it shall be understood that these are non-limiting examples of images, and other images of the item can also be used and are within the protection scope of the present disclosure.

The system analyzes the images using an image recognition and text extraction algorithm, such as optical character recognition (OCR), to identify and extract both textual elements and visual components (e.g., hazard symbols and regulatory pictograms) from the images. For items containing safety-related information, the system recognizes warning symbols and regulatory markings to include appropriate warning and compliance information. The identified and extracted information undergoes Chain of Thought (COT) verification using a trained AI model (e.g., a large language model (LLM), a Generative AI (Gen AI) model) to be organized into structured sections. The COT verification uses prompting techniques to verify the consistency between different sections of the descriptions generated by the trained AI model. The structured sections may include title, specification (e.g., size, weight, quantity), usage directions, danger warnings, chemical composition, manufacturer information, universal product code (UPC), model, manufacturing part number (MPN), brand, etc.

Next, the system displays the structured sections of the description of the item to a user via an interactive interface of a user device. The interactive interface may allow the user to accept, edit, decline, replace, review, or modify the automatically generated descriptions.

Finally, the descriptions of the item (based on the user's review or modification) may be published on the publication platform. This process is also referred to as product listing. If the system determines that product descriptions are insufficient, it can request additional images of the item from the sellers or search existing item databases to obtain the additional images. Additional information may be extracted from the additional images, and the published description of the item can be updated based on the information extracted from the additional images.

In summary, unlike traditional manual listing processes that are time-consuming and error-prone, the present system automatically extracts and processes text content from item images to generate accurate and complete item descriptions that can easily be edited by the users via an interactive interface. The automated extraction and verification process helps prevent listing errors that traditionally lead to buyer dissatisfaction and product returns. The present system also ensures regulatory compliance through automatic identification and extraction of safety warnings, hazard symbols, and disclaimers that sellers often omit from their listings.

Reference will now be made in detail to embodiments of the present disclosure, examples of which are illustrated in the appended drawings. The present disclosure may, however, be embodied in many different forms and should not be construed as being limited to the embodiments set forth herein.

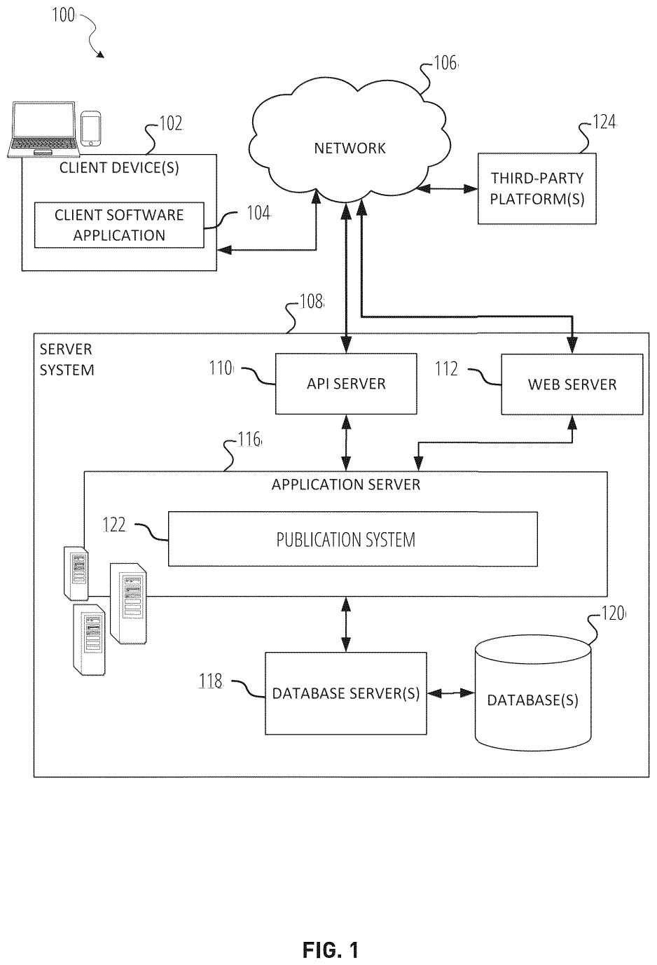

FIG. 1 is a block diagram showing an example data system 100 that includes a publication system 122 (also referred to as system 122), according to various embodiments of the present disclosure. As shown, the data system 100 includes one or more client devices 102, a server system 108, and a network 106 (e.g., Internet, wide-area-network (WAN), local-area-network (LAN), wireless network) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the data system 100 are described herein as being performed by the publication system 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the publication system 122. Such operations include transmitting data from the publication system 122 to the client software application 104, receiving data from the client software application 104 at the publication system 122, and the publication system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, an Application Program Interface (API) server 110 and a web server 112 is coupled to an application server 116, which hosts the publication system 122. The application server 116 is communicatively coupled to a database server 118, which facilitates access to a database 120 that stores data associated with the application server 116, including data that may be generated or used by the publication system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation, user registration; login functionality; data object operations (e.g., generating, storing, retrieving, encrypting, decrypting, transferring, access rights, licensing); and/or user communications.

The server system 108, or the publication system 122 may extract user data from one or more third-party platforms 124 (e.g., third-party social media platforms).

Through one or more web-based interfaces (e.g., web-based user interfaces), the web server 112 can support various functionality of the publication system 122 of the application server 116.

The publication system 122 can interface with the application server 116 and database server(s) 118 to manage data flow within the server system. The publication system 122 coordinates with the database server(s) 118 or the network 106 to access and store data in the database(s) 120 or the third-party platform 124, enabling the system to retrieve and process specifications of items to be published or previously published on a publication platform for generating or updating listing(s) of the items. The publication system 122 instructs the client software application 104 to display an interactive interface on the client device 102 via the network 106 and receives user interaction(s) with the interactive interface via the same network 106.

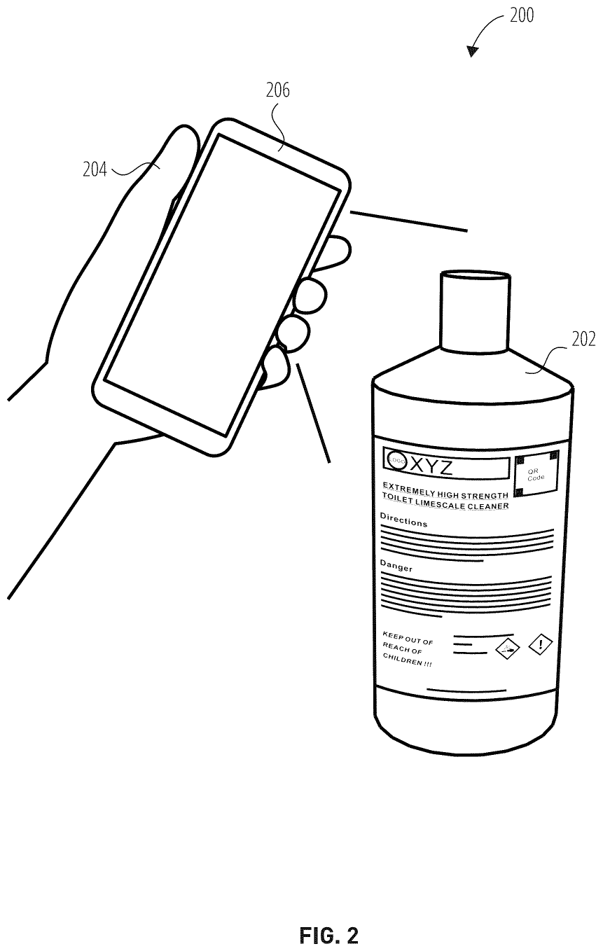

FIG. 2 is a schematic diagram 200 illustrating capturing of images of an item 202 using a user device 206, according to various embodiments of the present disclosure.

The user device 206 may include various types of computing devices, such as a mobile phone, a tablet computer, a laptop computer, or other portable electronic devices capable of capturing images. The user device 206 may include one or more image capture components, such as a camera, an infrared camera, a depth camera, or other optical sensors that can capture images. A user 204 may execute a client software application 104 installed on the user device 206 to activate the camera and capture images. A client software application (e.g., the client software application 104) enables the user device 206 to communicate with a server system (e.g., the server system 108) through a network (e.g., the network 106) to upload the captured images for processing. The user device 206 may correspond to the client device 102 shown in FIG. 1.

In the example shown in FIG. 2, user 204 captures an image of item 202 using user device 206. Merely by way of example, item 202, shown in FIG. 2, is a toilet limescale cleaner manufactured by XYZ company that contains hazardous materials requiring specific warning labels and safety information. However, this is just an example and shall not be limiting. The item can be any product that a user wishes to list on the publication platform. The image that the user 204 captures may include a label of the item 202, which contains various types of information about the item, such as item name, directions for use, danger warnings, chemical composition, manufacturer details, safety symbols, etc.

The server system can then extract text content from these images using optical character recognition (OCR) and generate structured sections of item descriptions using chain of thought (COT) verifications and a trained artificial intelligence (AI) model. Details regarding text extraction and description generation may be found in subsequent figures of the present disclosure and descriptions thereof.

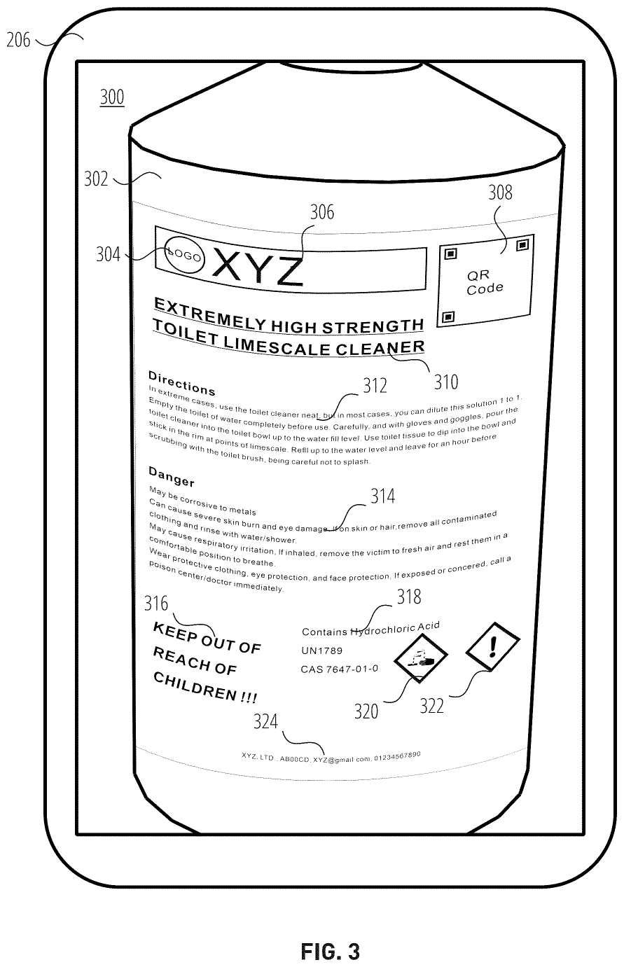

FIG. 3 is a schematic diagram illustrating an example captured image 300 of the item 202 displayed on the user device 206, according to various embodiments of the present disclosure.

The captured image 300 shows a label 302 of the item 202 displayed on the user device 206. The label 302 includes various components arranged in a disorganized manner with different fonts, sizes, and layouts across the label 302. At the top portion of the label 302, there is a brand logo 304 of the item 202, followed by a brand name 306 “XYZ” and a Quick Response (QR) code 308 positioned on the right side. Below that is the name of the item 310 “EXTREMELY HIGH STRENGTH TOILET LIMESCALE CLEANER” in large text.

The usage directions 312 are presented as a single dense paragraph of text that is difficult to parse, lacking clear step-by-step organization. The usage directions 312 describe dilution ratios, application methods, and safety precautions in a continuous block of text without clear separation or highlighting of key points. This unstructured format makes it challenging for users to quickly locate specific instructions.

The dangers section 314 contains safety information but is not prominently highlighted or structured for easy comprehension. Many hazard statements about corrosion risks, skin/eye damage, and respiratory irritation are combined together without clear organization. A warning message 316 about keeping out of reach of children appears below, though not prominently emphasized despite its importance.

The chemical composition section 318 lists “Contains Hydrochloric Acid” along with identification codes UN1789 and CAS 7647-01-0 but there is no information about what these identification codes refer to. Safety symbols, including a corrosive symbol 320 and an irritant symbol 322, are placed on a less noticeable lower right corner of the label 302. At the bottom of the label 302, contact information 324 for the manufacturing company including name, address (postal code), email, and phone is provided in small text.

When a user manually enters product information from such an unstructured label, it is highly likely that critical safety warnings, regulatory compliance details, and important product specifications are missing or inaccurately entered. This leads to incomplete listings that can result in buyer dissatisfaction and product returns.

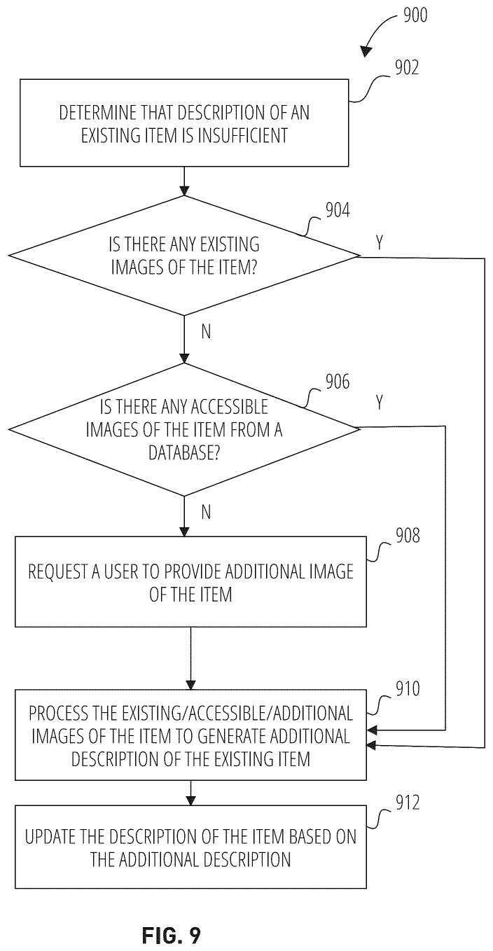

While optical character recognition (OCR) alone can extract text from the label, it does not completely solve the problem because product information sections are merged together without clear structures. To address this, the system uses a trained AI model with a Chain of Thought (COT) verification. First, the system uses a trained AI model to process the extracted text to generate an initial description of the item. Then, the system applies COT prompting techniques to break down the text content into logical sections, verify consistency between different sections, identify and properly categorize safety warnings, structure information in a clear hierarchy, and self-verify the accuracy of the generated description. The system only outputs the description once it passes the self-verification process. For example, the self-verification process may include verifying whether the extracted chemical composition aligns with the associated dangers section, e.g., whether “Contains hydrochloric acid” is related to “severe skin/eye damage and respiratory irritation.” As another example, the self-verification process may include checking whether all warning symbols or pictograms are included. This approach helps ensure that critical item information is not only extracted but also properly organized and verified for accuracy before being presented to users. Details regarding the COT verification can be found in FIG. 9 and the descriptions thereof.

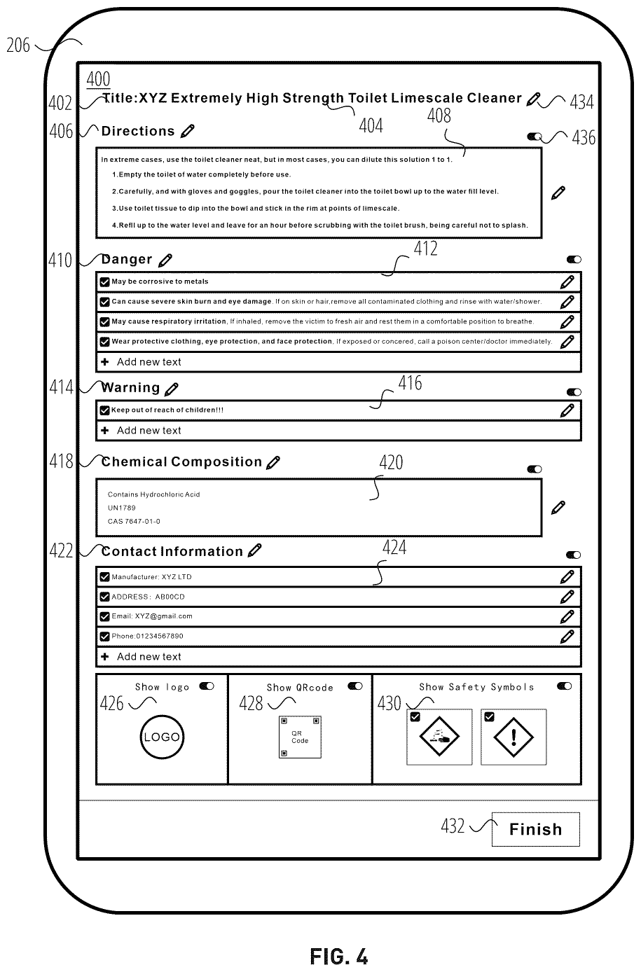

FIG. 4 is a diagram illustrating an interactive interface 400 for editing and/or modifying extracted item descriptions displayed on the user device 206, according to various embodiments of the present disclosure. The interactive interface 400 displays extracted information in a structured, organized format that allows users to easily review and modify the content. The interface 400 includes a title heading 402 at the top, with the extracted title 404 showing “XYZ Extremely High Strength Toilet Limescale Cleaner.” The title heading 402 and extracted title have been intelligently repositioned from their original scattered location on label 302 to the top of the interface 400 for better readability.

The interface 400 provides editing capabilities through pen icons 434 next to each section, which when clicked, make the corresponding section editable. In some embodiments, direct text editing is enabled by clicking on the text itself without requiring the pen icon 434.

The interface 400 includes a usage directions section with a heading 406 followed by the extracted directions 408. Compared with the original unstructured paragraph, the system has automatically organized the directions into clear, numbered steps. A toggle button 436 is provided for the usage directions section and/or each of the other non-compulsory sections that allow the user to choose whether to display or hide the corresponding section in the final item listing.

Below the directions section is a danger section with a heading 410 followed by extracted dangers 412. Each danger is presented with a selectable checkbox, allowing users to include or exclude specific dangers in the final item listing. Users can also manually add new dangers that may not have been shown on the original label 302 through an “Add new text” option.

The interface 400 includes a warning section with heading 414. Even though there was no explicit “warning” section on the original label 302, the system identified that the text 416 “KEEP OUT OF REACH OF CHILDREN!!!” should be categorized as a warning. Users can manually add additional warnings through an “Add new text” option. In some example embodiments, the danger section may be combined with the warning section.

Similar to the warning section, a chemical composition section with heading 418 has been automatically created by the system, even though this heading 418 does not exist on the original label 302. The extracted chemical composition 420 includes both the chemical composition information and associated identification codes in a structured format.

The contact information section consolidates manufacturer details that were previously distributed across label 302 under an automatically generated heading 422. The extracted contact information 424 presents each contact detail (e.g., manufacturer name, address, email, phone) with individually selectable checkboxes, allowing the seller to choose which information to display in the final listing.

At the bottom of the interface 400 are toggleable options for displaying the logo 426, QR code 428, and safety symbols 430. The safety symbols 430 can be individually selected or deselected for inclusion in the final listing by selecting/deselecting the corresponding box. In some example embodiments, safety warnings (in text) corresponding to the safety symbols 430 may be chosen to be displayed.

A finish button 432 allows users to proceed with publishing the description once they have completed their review and modifications.

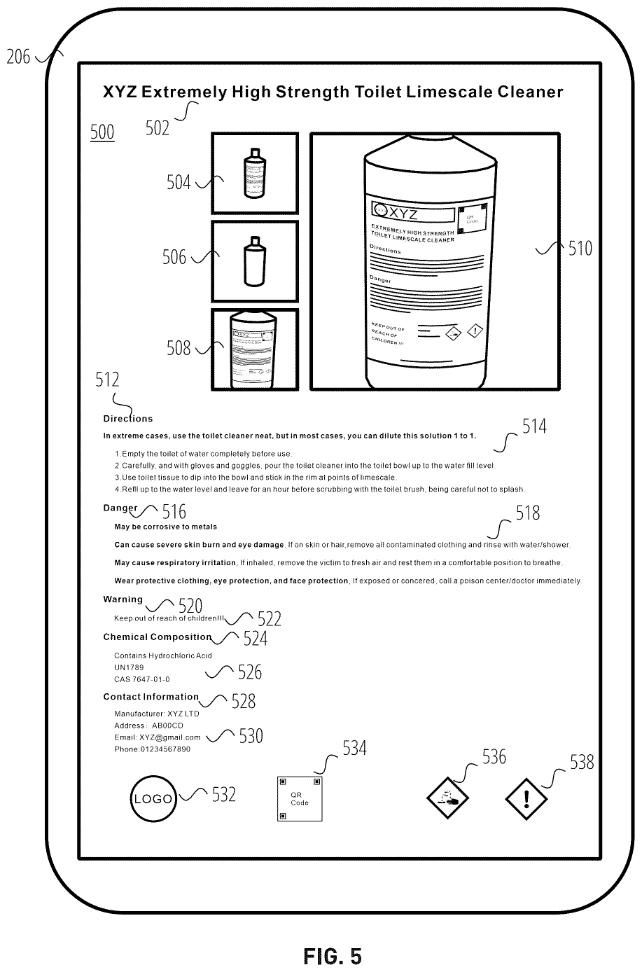

FIG. 5 is a diagram illustrating an example webpage 500 of the item listing with extracted and modified item descriptions displayed on the user device 206, according to various embodiments of the present disclosure.

The webpage 500 displays a final published listing of the item 202 that potential buyers can view on the publication platform. The webpage 500 includes a title section 502 showing “XYZ Extremely High Strength Toilet Limescale Cleaner” prominently positioned at the top.

The webpage 500 features a gallery of product images arranged vertically on the left side, including a front view 504, a back view 506, and a close-up view 508 of the item's label. The close-up view 508 corresponds to the captured image 300, showing the detailed label 302 of item 202. A larger featured image 510 is displayed prominently on the right side of the webpage.

Below the images, the webpage 500 presents the extracted and processed information in clearly organized sections. The directions section 512 includes a heading followed by extracted and/or modified directions 514 that have been automatically formatted into numbered steps for easy comprehension. The danger section with heading 516 displays the extracted and/or modified dangers 518 in a structured format, followed by a warning section with heading 520 that includes the warning text 522 “Keep out of reach of children!!!”

The chemical composition section with heading 524 clearly presents the chemical information 526, including the active ingredient “Contains Hydrochloric Acid” along with its associated identification codes.

The contact information section with heading 528 provides comprehensive manufacturer details 530, including the company name, address, email and phone number in an organized format.

For additional product verification and safety information, the webpage displays the company logo 532, QR code 534, and safety symbols 536 and 538 that were extracted from the original item label 302.

The webpage 500 transforms the originally scattered information from the product label into a standardized, user-friendly format. This structured presentation ensures that buyers can easily locate essential product information, safety warnings, and manufacturer details while helping sellers maintain regulatory compliance.

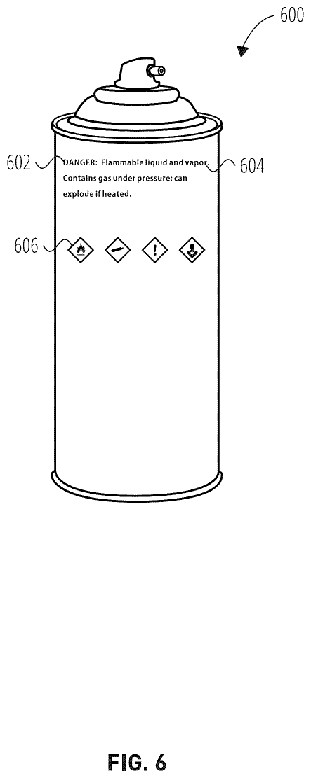

FIG. 6 is a diagram illustrating an example item 600 with hazard symbols 606, and warning statement 604 that can be automatically detected and extracted, according to various embodiments of the present disclosure.

Merely by way of example, the item 600 is an aerosol spray can containing hazardous materials that require specific warning labels and safety information. The item 600 includes a signal word “DANGER”602, followed by two warning statements 604: “Flammable liquid and vapor” and “Contains gas under pressure; can explode if heated.” The item 600 includes multiple hazard symbols 606 arranged horizontally. These pictograms indicate specific types of hazards associated with the product, such as flammability and pressure hazards.

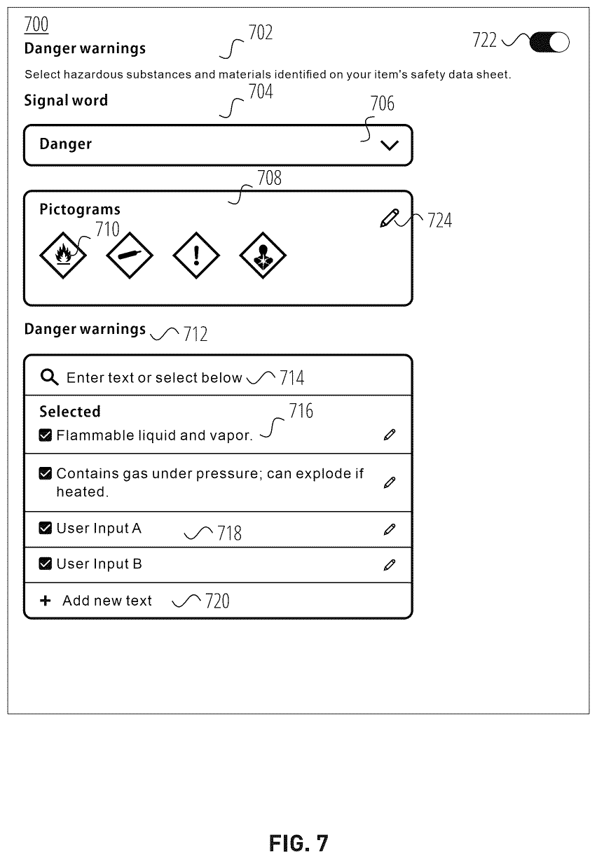

The system can automatically detect and extract both the signal word, warning statements, and hazard pictograms to ensure regulatory compliance in the item listing. Through optical character recognition and subsequent execution of AI model with COT verification, the system identifies the signal word 602 and associated warning statements 604, while also capturing hazard symbols 606 to generate comprehensive product descriptions that include all required safety information. The extracted safety information can then be presented to users through the interactive interface 700 shown in FIG. 7, allowing the user to review and modify them before publishing the final item listing.

FIG. 7 is a diagram illustrating an interactive interface 700 for selecting and/or editing hazard warnings for item descriptions, according to various embodiments of the present disclosure.

The interface 700 includes a danger warnings section 702 that prompts users to select hazardous substances and materials identified on their item's image. A toggle switch 722 at the top right enables users to activate or deactivate the danger warnings section in the final listing.

A signal word section 704 includes a dropdown menu 706 pre-populated with regulatory or warning terms such as “warning,” “danger,” “caution,” “notice,” “poison,” and “!” that relate to item safety requirements. These standardized signal words indicate different levels of hazard severity, with “danger” potentially representing the highest level of hazard.

Below the signal word section is a pictograms section 708 displaying hazard symbols 710 identified from the image of the item 600. In some example embodiments, the symbols displayed on the item may not be commonly used, and the pictograms section 708 may replace the symbols displayed on the item with more commonly used or standardized symbols that have the same or similar meanings. A pen icon 724 allows users to edit or modify the selected pictograms.

The interface 700 includes a danger warnings section 712 with a search field 714 where users can search for extracted or user-inputted danger warnings. The interface 700 may display warnings 716 that have been automatically identified and extracted from the item images, such as “Flammable liquid and vapor” and “Contains gas under pressure; can explode if heated.” In addition, the interface 700 may include user-inputted warnings 718 that can be added through the “Add new text” option 720.

Through this structured interface, the system enables users to review and modify automatically extracted hazard information to ensure regulatory compliance. The combination of automated extraction and manual editing capabilities helps maintain the accuracy of critical safety information in product listings.

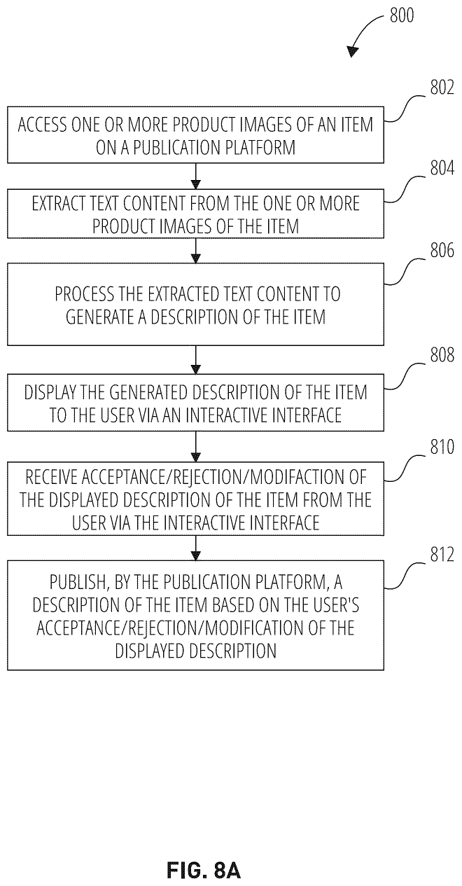

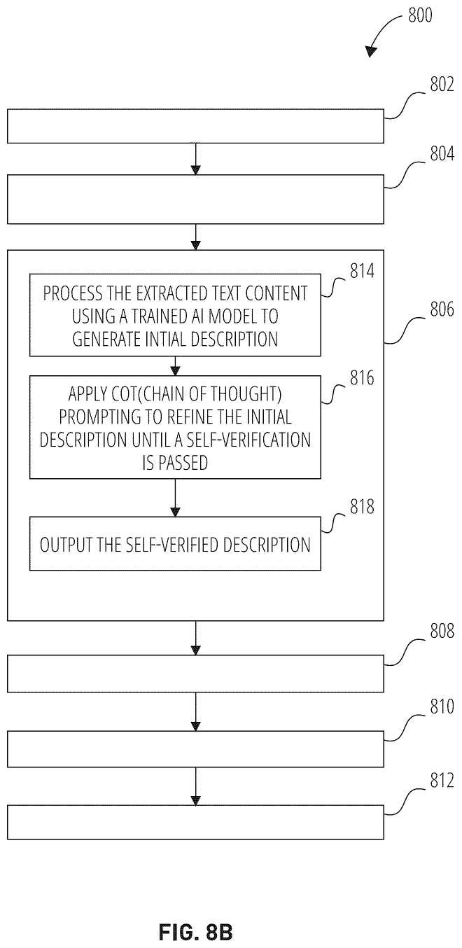

FIG. 8A is a flowchart illustrating an example method 800 for generating product listings, according to various embodiments of the present disclosure. It will be understood that example methods described herein may be performed by a machine in accordance with some embodiments. For example, method 800 can be performed by the client device 102, the server system 108, the publication system 122, or individual components thereof. An operation of method 800 may be performed by one or more hardware processors (e.g., central processing units or graphics processing units) of a computing device (e.g., a desktop, server, laptop, mobile phone, tablet, etc.), which may be part of a computing system based on a cloud architecture. The method 800 may also be implemented in the form of executable instructions stored on a machine-readable medium or in the form of electronic circuitry. For instance, the operations of method 800 may be represented by executable instructions that, when executed by a processor of a computing device, cause the computing device to perform method 800. Depending on the embodiment, an operation of the method 800 may be repeated in different ways or involve intervening operations not shown. Though the operations of the method 800 may be depicted and described in a certain order, the order in which the operations are performed may vary among embodiments, including performing certain operations in parallel.

At operation 802, a system (e.g., the publication system 122) accesses one or more product images of an item on a publication platform or to be published on the publication platform. The images may include user-captured images through the client device's camera, existing product images from the publication platform's database, or third-party images obtained by executing APIs of a third-party platform. The images may include product packaging, labels, safety data sheets, or other materials of the item containing textual information about the item.

At operation 804, the system extracts text content from the one or more product images using optical character recognition and text extraction algorithms. This extraction operation captures product specifications, safety warnings, regulatory information, and other relevant details present in the images.

At operation 806, the system processes the extracted text content to generate a description of the item. Specifically, operation 806 may include a trained AI model to generate an initial description from the extracted text. Then, Chain of Thought (COT) prompting techniques are applied to refine the description by breaking down content into logical sections, verifying consistency between sections, categorizing safety warnings appropriately, and structuring information hierarchically. The system performs self-verification before outputting the final description. In some example embodiments, operations 804 and 806 of FIG. 8 may be combined into a single operation that both extracts text content from the product images and processes the extracted content to generate the item description. Other types of image recognition, text extraction, description generation algorithms, or models may be used without departing from the spirit of the present disclosure. Such variations are also within the protection scope of the present disclosure.

At operation 808, the system displays the generated description to the user via an interactive interface. The interface presents the extracted information in clearly organized sections that can be individually reviewed, toggled, or modified by the user, as demonstrated in interfaces 400 and 700 shown in FIGS. 4 and 7, respectively.

At operation 810, the system receives the user's acceptance, rejection, or modification of the displayed description through the interactive interface. Users can edit text, add new information, select/deselect specific sections, and control what information appears in the final listing using features like toggle switches, pen icons, and “Add new text” options. “Acceptance,” as used herein, may refer to the user selecting a checkbox corresponding to extracted text without modifying it. “Rejection,” as used herein, refers to the user deselecting a checkbox corresponding to extracted text or toggling off a whole structured section of description.

At operation 812, based on the user's review or modification of the displayed description, the publication platform publishes the final description of the item. This ensures that the published listing contains accurate, complete, and properly structured information that complies with regulatory requirements while meeting the seller's personal preferences.

In some example embodiments, the system may translate extracted text content from a first language to a second language and generate the description in the second language.

In some example embodiments, the system may identify a plurality of items on the publication platform to target for description updates, access image data associated with each identified item, extract text content from the image data, determine updated descriptions, and automatically update the descriptions for the plurality of items. The update of descriptions of items on the publication platform may be periodically conducted, e.g., every hour, every day, every week, etc.

In some example embodiments, the system may expose the text extraction and description generation capabilities through an API service in an AI platform to enable integration with other systems.

In some example embodiments, the extracted text may include country of manufacture, a universal product code (UPC), a model, a manufacturing part number (MPN), a brand, or manufacturer information.

In some example embodiments, the system may utilize the extracted text content to generate accessibility descriptions of the product images. The accessibility descriptions enable visually impaired users who rely on screen readers and other assistive technologies to understand crucial product information, safety warnings, and usage instructions that are embedded within the images. This automated conversion of visual content into accessible text format helps ensure that product listings are fully accessible to all users of the publication platform.

In some examples, the system may leverage language models to automatically transform the extracted text content into well-structured e-commerce listing components. The language models can process the raw extracted text to generate optimized listing titles that highlight key product features, detailed product descriptions organized in a clear and engaging format, and comprehensive item specifics that capture important product attributes. This automated transformation helps ensure consistency across listings while reducing the manual effort required from sellers to create complete and accurate product listings.

In some example embodiments, the system may integrate with brain-computer interface (BCI) technology to enable real-time product sensing and listing. The BCI implementation would utilize retinal implants that allow sellers to create listings through direct thought processes while viewing products. This technology would work in conjunction with brain wave detection and electromagnetic flux detection to translate cognitive signals into actionable listing data. The system would be able to distinguish between multiple viewed items based on the seller's cognitive signals, allowing them to mentally select which items they want to list while filtering out items they don't intend to sell.

FIG. 8B is a flowchart illustrating an example of operations 814-818 for processing extracted text content using a trained Artificial Intelligence (AI) model and a Chain of Thought (COT) verification to generate item descriptions, according to various embodiments of the present disclosure. Operations 802, 804, 808, 810, and 812 may be similar to those described with reference to FIG. 8A and hence are not repeated herein. The operation 806 may include operations 814, 816, and 818.

At operation 814, the system (e.g., the publication system 122) processes the extracted text content using a trained AI model to generate an initial description. In some example embodiments, the AI model is trained using a large dataset of product listings and their corresponding images from the publication platform's database. The training data includes product packaging images, safety data sheets, and labels with properly structured descriptions that comply with regulatory requirements. The model may be trained using supervised learning techniques where the cost function minimizes the difference between generated descriptions and human-curated ground truth descriptions. The training process may focus on accurately identifying and categorizing key product information, including specifications, safety warnings, regulatory details, hazard symbols, etc.

At operation 816, the system applies Chain of Thought (COT) prompting techniques to refine the initial description until a self-verification is passed. The COT approach is a systematic verification process that breaks down complex information processing into logical steps. First, the system breaks down the generated descriptions into distinct sections like directions, warnings, chemical composition, etc. Next, it cross-references information between sections to verify consistency, such as ensuring safety warnings match identified hazard pictograms. The system then categorizes hazard information based on severity and type, distinguishing between signal words and warning statements. Finally, it structures the information hierarchically with proper headings and sections.

At operation 818, once the self-verification passes, the system outputs the self-verified description. Terminal conditions that must be met for the Chain of Thought (COT) self-verification to pass may include but are not limited to 1. all critical safety information from the product images is captured; 2. all required regulatory warnings and hazard symbols are properly identified; 3. all essential product specifications (e.g., specifications, chemical composition, directions, contact information) are included; 4. extracted text matches the original content from images; 5. safety warnings correspond correctly to identified hazard pictograms; 6. chemical compositions align with associated warning statements; 7. content is properly organized into distinct sections; 8. information hierarchy follows a logical flow; 9. related information is properly grouped together; 10. all mandatory safety disclaimers are present; 11. hazard classifications are correctly categorized by severity level; 12. required warning symbols and pictograms are included; 13. Text is clear and understandable; 14. formatting is consistent and properly structured; and 15. multi-language content (if present) is accurately translated.

FIG. 9 is a flowchart illustrating an example method 900 for handling insufficient item descriptions, according to various embodiments of the present disclosure. For example, method 900 can be performed by the client device 102, the server system 108, the publication system 122, or individual components thereof. An operation of method 900 may be performed by one or more hardware processors (e.g., central processing units or graphics processing units) of a computing device (e.g., a desktop, server, laptop, mobile phone, tablet, etc.), which may be part of a computing system based on a cloud architecture. The method 900 may also be implemented in the form of executable instructions stored on a machine-readable medium or in the form of electronic circuitry. For instance, the operations of method 900 may be represented by executable instructions that, when executed by a processor of a computing device, cause the computing device to perform method 900. Depending on the embodiment, an operation of the method 900 may be repeated in different ways or involve intervening operations not shown. Though the operations of the method 900 may be depicted and described in a certain order, the order in which the operations are performed may vary among embodiments, including performing certain operations in parallel.

At operation 902, a system (e.g., the publication system 122) determines that a description of an existing item is insufficient. This determination may be based on missing important information, incomplete specifications, or inadequate safety warnings that are required for regulatory compliance.

At operation 904, the system checks whether there are any existing images of the item. If existing images are found (e.g., “Y” branch), the method 900 proceeds to operation 910. If no existing images are found (e.g., “N” branch), the method 900 proceeds to operation 906.

At operation 906, the system checks whether there are any accessible images of the item from a database. This may include searching product databases, manufacturer catalogs, 3^{rd} party platform databases (via API), or other image repositories. If accessible images are found (e.g., “Y” branch), the method 900 proceeds to operation 910. If no accessible images are found (e.g., “N” branch), the method 900 proceeds to operation 908.

At operation 908, the system requests a user to provide additional images of the item. This request may be made through a notification to a user device of the user. The request may prompt the seller to capture and upload additional images of the item (via the client software application 104).

At operation 910, the system processes the existing images, the accessible image, or the additional images of the item to generate additional descriptions of the existing item. The system may employ an operation similar to operations 804 and/or 806 to generate additional descriptions of the item based on these images.

At operation 912, the system updates the description of the item based on the additional description generated from the processed images.

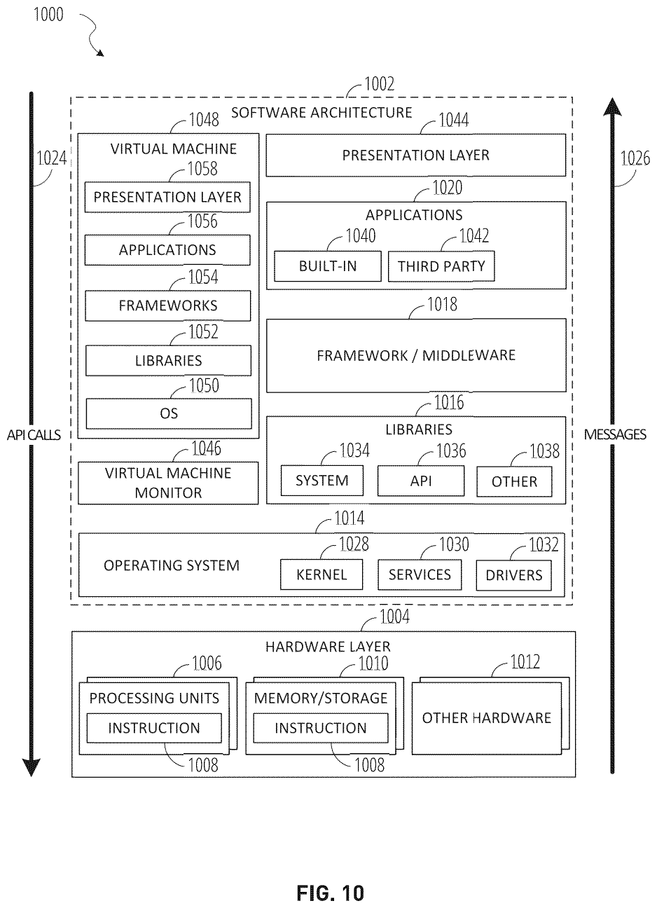

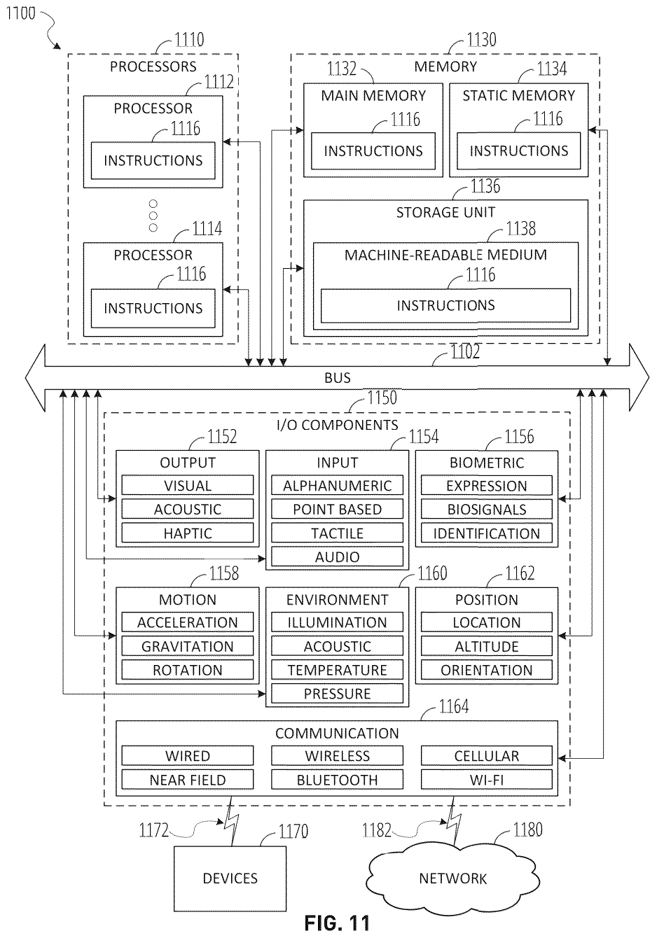

FIG. 10 is a block diagram illustrating an example of a software architecture 1002 that may be installed on a machine, according to some example embodiments. FIG. 10 is merely a non-limiting example of a software architecture, and it will be appreciated that many other architectures may be implemented to facilitate the functionality described herein. The software architecture 1002 may be executing on hardware such as a machine 1100 of FIG. 11 that includes, among other things, processors 1110, memory 1130, and input/output (I/O) components 1150. A representative hardware layer 1004 is illustrated and can represent, for example, the machine 1100 of FIG. 11. The representative hardware layer 1004 comprises one or more processing units 1006 having associated executable instructions 1008. The executable instructions 1008 represent the executable instructions of the software architecture 1002. The hardware layer 1004 also includes memory or storage modules 1010, which also have the executable instructions 1008. The hardware layer 1004 may also comprise other hardware 1012, which represents any other hardware of the hardware layer 1004, such as the other hardware illustrated as part of the machine 1100.

In the example architecture of FIG. 10, the software architecture 1002 may be conceptualized as a stack of layers, where each layer provides particular functionality. For example, the software architecture 1002 may include layers such as an operating system 1014, libraries 1016, frameworks/middleware 1018, applications 1020, and a presentation layer 1044. Operationally, the applications 1020 or other components within the layers may invoke API calls 1024 through the software stack and receive a response, returned values, and so forth (illustrated as messages 1026) in response to the API calls 1024. The layers illustrated are representative in nature, and not all software architectures have all layers. For example, some mobile or special-purpose operating systems may not provide a frameworks/middleware 1018 layer, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than by interfacing directly with the underlying operating system 1014 functionality (e.g., kernel 1028, services 1030, or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks 1018 (also sometimes referred to as middleware) may provide a higher-level common infrastructure that may be utilized by the applications 1020 or other software components/modules. For example, the frameworks 1018 may provide various graphical user interface functions, high-level resource management, high-level location services, and so forth. The frameworks 1018 may provide a broad spectrum of other APIs that may be utilized by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a home application, a contacts application, a browser application, a book reader application, a location application, a media application, a messaging application, or a game application.

The third-party applications 1042 may include any of the built-in applications 1040, as well as a broad assortment of other applications. In a specific example, the third-party applications 1042 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 1042 may invoke the API calls 1024 provided by the mobile operating system such as the operating system 1014 to facilitate functionality described herein.

The applications 1020 may utilize built-in operating system functions (e.g., kernel 1028, services 1030, or drivers 1032), libraries (e.g., system libraries 1034, API libraries 1036, and other libraries 1038), or frameworks/middleware 1018 to create user interfaces to interact with users of the system. Alternatively, or additionally, in some systems, interactions with a user may occur through a presentation layer, such as the presentation layer 1044. In these systems, the application/module “logic” can be separated from the aspects of the application/module that interact with the user.

Some software architectures utilize virtual machines. In the example of FIG. 10, this is illustrated by a virtual machine 1048. The virtual machine 1048 creates a software environment where applications/modules can execute as if they were executing on a hardware machine. The virtual machine 1048 is hosted by a host operating system (e.g., the operating system 1014) and typically, although not always, has a virtual machine monitor 1046, which manages the operation of the virtual machine 1048 as well as the interface with the host operating system (e.g., the operating system 1014). A software architecture executes within the virtual machine 1048, such as an operating system 1050, libraries 1052, frameworks 1054, applications 1056, or a presentation layer 1058. These layers of software architecture executing within the virtual machine 1048 can be the same as corresponding layers previously described or may be different.

FIG. 11 illustrates a diagrammatic representation of a machine 1100 in the form of a computer system within which a set of instructions may be executed for causing the machine 1100 to perform any one or more of the methodologies discussed herein, according to an embodiment. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example, the instructions 1116 may cause the machine 1100 to execute the method 800 described above with respect to FIGS. 8A and 8B and the method 900 described above with respect to FIG. 9. The instructions 1116 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an embodiment, the processors 1110 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1112 and a processor 1114 that may execute the instructions 1116. The term “processor” is intended to include multi-core processors that may comprise two or more independent processors (sometimes referred to as “cores”) that may execute instructions contemporaneously. Although FIG. 11 shows multiple processors 1110, the machine 1100 may include a single processor with a single core, a single processor with multiple cores (e.g., a multi-core processor), multiple processors with a single core, multiple processors with multiples cores, or any combination thereof.

The memory 1130 may include a main memory 1132, a static memory 1134, and a storage unit 1136 including machine-readable medium 1138, each accessible to the processors 1110 such as via the bus 1102. The main memory 1132, the static memory 1134, and the storage unit 1136 store the instructions 1116 embodying any one or more of the methodologies or functions described herein. The instructions 1116 may also reside, completely or partially, within the main memory 1132, within the static memory 1134, within the storage unit 1136, within at least one of the processors 1110 (e.g., within the processor's cache memory), or any suitable combination thereof, during execution thereof by the machine 1100.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion, and the grouping is in no way limiting. In some examples, the I/O components 1150 may include output components 1152 and input components 1154. The output components 1152 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 1150 may include biometric components 1156, motion components 1158, environmental components 1160, or position components 1162, among a wide array of other components. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1162 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a USB).

Moreover, the communication components 1164 may detect identifiers or include components operable to detect identifiers. For example, the communication components 1164 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some examples, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 1100 including processors 1110), with these operations being accessible via a network (e.g., the Internet) and via one or more appropriate interfaces (e.g., an API). In certain embodiments, for example, a client device may relay or operate in communication with cloud computing systems and may access circuit design information in a cloud environment.

The performance of certain of the operations may be distributed among the processors, not only residing within a single machine 1100, but deployed across a number of machines 1100. In some example embodiments, the processors 1110 or processor-implemented modules are located in a single geographic location (e.g., within a home environment, an office environment, or a server farm). In other example embodiments, the processors or processor-implemented modules are distributed across a number of geographic locations.

The various memories and/or the storage unit 1136 may store one or more sets of instructions 1116 and data structures (e.g., software) embodying or utilized by any one or more of the methodologies or functions described herein. These instructions (e.g., the instructions 1116), when executed by the processor(s), cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1116 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In some examples, one or more portions of the network 1180 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 1170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

Example 1. A system comprising: one or more hardware processors; and at least one machine-storage medium storing instructions that, when executed by the one or more hardware processors, cause the system to perform operations comprising: accessing one or more images of an item on a publication platform; extracting text content from the one or more images of the item; determining a description of the item based on the extracted text content; causing display of the description of the item on an interactive interface on a user device; receiving, via the interactive interface, a response to the displayed description (e.g., a modification of the displayed description by a user of the user device); and publishing, on the publication platform, a modified description based on the response to the displayed description.

Example 2. The system of example 1, wherein the extracted text content comprises regulatory information or warning information about the item.

Example 3. The system of example 2, wherein the regulatory information or warning information about the item is extracted based on an identification of a hazardous material symbol in the one or more images.

Example 4. The system of any one of examples 1-3, wherein the extracting of the text content from the one or more images of the item comprises extracting the text content using an image recognition and text extraction algorithm.

Example 5. The system of any one of examples 1-4, wherein the determining of the description of the item comprises determining the description based on the extracted text content using a Chain of Thought (COT) algorithm.

Example 6. The system of any one of examples 1-5, wherein the operations further comprise: identifying a plurality of items on the publication platform to target for description updates; accessing image data associated with each of the identified plurality of items; extracting the text content from image data for the each of the identified plurality of items; determining an updated description for the each of the identified plurality of items based on the corresponding extracted text content; and automatically updating the description for the plurality of items on the publication platform.

Example 7. The system of any one of examples 1-6, wherein the operations further comprise: determining the description of the item is insufficient; and in response to determining the description of the item is insufficient, generating a notification to a user requesting the user to provide additional images of the item.

Example 8. The system of example 7, wherein the operations further comprise: receiving the additional item images provided by the user; extracting text content of the additional item images; determining additional description of the item based on the extracted text content of the additional item images; and publishing the additional description of the item on the publication platform.

Example 9. The system of any one of examples 1-8, wherein the description comprises at least one of: a country of manufacture, a universal product code (UPC), a model, a manufacturing part number (MPN), a brand, or manufacturer information.

Example 10. The system of any one of examples 1-9, wherein the extracted text content corresponds to a first language, wherein the operations further comprise: translating the extracted text content in the first language to a second language; and determining the description of the item in the second language based on the translated text content.

Example 11. The system of any one of examples 1-10, wherein the one or more images comprise images of a package of the item.

Example 12. A method comprising: accessing one or more images of an item on a publication platform; extracting text content from the one or more images of the item; determining a description of the item based on the extracted text content; causing display of the description of the item on an interactive interface on a user device; receiving, via the interactive interface, a response to the displayed description; and publishing, on the publication platform, a modified description based on the response to the displayed description.

Example 13. The method of example 12, wherein the extracted text content comprises regulatory information or warning information about the item.

Example 14. The method of example 13, wherein the regulatory information or warning information about the item is extracted based on an identification of a hazardous material symbol in the one or more images.

Example 15. The method of any one of examples 12-14, wherein the extracting of the text content from the one or more images of the item comprises extracting the text content using an image recognition and text extraction algorithm.

Example 16. The method of any one of examples 12-15, wherein the determining of the description of the item comprises determining the description based on the extracted text content using a Chain of Thought (COT) algorithm.

Example 17. The method of any one of examples 12-16, further comprising: identifying a plurality of items on the publication platform to target for description updates; accessing image data associated with each of the identified plurality of items; extracting the text content from image data for the each of the identified plurality of items; determining an updated description for the each of the identified plurality of items based on the corresponding extracted text content; and automatically updating the description for the plurality of items on the publication platform.

Example 18. The method of any one of examples 12-17, further comprising: determining the description of the item is insufficient; and in response to determining the description of the item is insufficient, generating a notification to a user requesting the user to provide additional images of the item.

Example 19. The method of example 18, further comprising: receiving the additional item images provided by the user; extracting text content of the additional item images; determining additional description of the item based on the extracted text content of the additional item images; and publishing the additional description of the item on the publication platform.

Example 20. A machine-storage medium for storing instructions that, when executed by one or more hardware processors, cause the one or more hardware processors to perform operations comprising: accessing one or more images of an item on a publication platform; extracting text content from the one or more images of the item; determining a description of the item based on the extracted text content; causing display of the description of the item on an interactive interface on a user device; receiving, via the interactive interface, a response to the displayed description; and publishing, on the publication platform, a modified description based on the response to the displayed description.

What is claimed is:

1. A system comprising:
one or more hardware processors; and
at least one machine-storage medium storing instructions that, when executed by the one or more hardware processors, cause the system to perform operations comprising:
accessing one or more images of an item on a publication platform;
extracting text content from the one or more images of the item;
determining a description of the item based on the extracted text content;
causing display of the description of the item on an interactive interface on a user device;
receiving, via the interactive interface, a response to the displayed description; and
publishing, on the publication platform, a modified description based on the response to the displayed description.

2. The system of claim 1, wherein the extracted text content comprises regulatory information or warning information about the item.

3. The system of claim 2, wherein the regulatory information or warning information about the item is extracted based on an identification of a hazardous material symbol in the one or more images.

4. The system of claim 1, wherein the extracting of the text content from the one or more images of the item comprises extracting the text content using an image recognition and text extraction algorithm.

5. The system of claim 1, wherein the determining of the description of the item comprises determining the description based on the extracted text content using a Chain of Thought (COT) algorithm.

6. The system of claim 1, wherein the operations further comprise:
identifying a plurality of items on the publication platform to target for description updates;
accessing image data associated with each of the identified plurality of items;
extracting the text content from image data for the each of the identified plurality of items;
determining an updated description for the each of the identified plurality of items based on the corresponding extracted text content; and
automatically updating the description for the plurality of items on the publication platform.

7. The system of claim 1, wherein the operations further comprise:
determining the description of the item is insufficient; and
in response to determining the description of the item is insufficient, generating a notification to a user requesting the user to provide additional images of the item.

8. The system of claim 7, wherein the operations further comprise:
receiving the additional item images provided by the user;
extracting text content of the additional item images;
determining additional description of the item based on the extracted text content of the additional item images; and
publishing the additional description of the item on the publication platform.

9. The system of claim 1, wherein the description comprises at least one of: a country of manufacture, a universal product code (UPC), a model, a manufacturing part number (MPN), a brand, or manufacturer information.

10. The system of claim 1, wherein the extracted text content corresponds to a first language, wherein the operations further comprise:
translating the extracted text content in the first language to a second language; and
determining the description of the item in the second language based on the translated text content.

11. The system of claim 1, wherein the one or more images comprise images of a package of the item.

12. A method comprising:
accessing one or more images of an item on a publication platform;
extracting text content from the one or more images of the item;
determining a description of the item based on the extracted text content;
causing display of the description of the item on an interactive interface on a user device;
receiving, via the interactive interface, a response to the displayed description; and
publishing, on the publication platform, a modified description based on the response to the displayed description.

13. The method of claim 12, wherein the extracted text content comprises regulatory information or warning information about the item.

14. The method of claim 13, wherein the regulatory information or warning information about the item is extracted based on an identification of a hazardous material symbol in the one or more images.

15. The method of claim 12, wherein the extracting of the text content from the one or more images of the item comprises extracting the text content using an image recognition and text extraction algorithm.

16. The method of claim 12, wherein the determining of the description of the item comprises determining the description based on the extracted text content using a Chain of Thought (COT) algorithm.

17. The method of claim 12, further comprising:
identifying a plurality of items on the publication platform to target for description updates;
accessing image data associated with each of the identified plurality of items;
extracting the text content from image data for the each of the identified plurality of items;
determining an updated description for the each of the identified plurality of items based on the corresponding extracted text content; and
automatically updating the description for the plurality of items on the publication platform.

18. The method of claim 12, further comprising:
determining the description of the item is insufficient; and
in response to determining the description of the item is insufficient, generating a notification to a user requesting the user to provide additional images of the item.

19. The method of claim 18, further comprising:
receiving the additional item images provided by the user;
extracting text content of the additional item images;
determining additional description of the item based on the extracted text content of the additional item images; and
publishing the additional description of the item on the publication platform.

20. A machine-storage medium for storing instructions that, when executed by one or more hardware processors, cause the one or more hardware processors to perform operations comprising:
accessing one or more images of an item on a publication platform;
extracting text content from the one or more images of the item;
determining a description of the item based on the extracted text content;
causing display of the description of the item on an interactive interface on a user device;
receiving, via the interactive interface, a response to the displayed description; and
publishing, on the publication platform, a modified description based on the response to the displayed description.
